(19) United States
(12) Patent Application Publication
(10) Pub. No.: US 2019/0340691 A1
(43) Pub. Date: Nov. 7, 2019

(54) EIAP® Equity Benefit Disbursement Method

(71) Applicant: The Westport Group, Braintree, MA (US)

(72) Inventors: Christopher R. Kristian, Hanover, MA (US); Gary F. Terry, Hingham, MA (US)

(21) Appl. No.: 15/968,054

(22) Filed: May 1, 2018

(51) Int. Cl. G06Q 40/08; G06Q 40/06

(52) U.S. Cl. CPC G06Q 40/08; G06Q 40/06

(57) ABSTRACT

The present invention is related to the field of disability insurance. For example, the invention provides for a disbursement method termed an executive insurance assurance plan (EIAP®) for equity benefits. An EIAP® Equity Benefit plan provides coverage for an executive that had previously uninsured compensation.

### FIELD OF THE INVENTION

The present invention is related to the field of disability insurance. For example, the invention provides for a disbursement method termed an executive income assurance plan (EIAP®) for equity benefits. The EIAP® Equity Benefit provides coverage for an executive that had previously uninsured compensation.

### BACKGROUND

The most valuable asset a person has is his or her ability to work and earn an income. Disability insurance was initially designed to provide protection to individuals if they could no longer provide the services their employer required due to sickness or injury. Disability insurance has progressed to cover most, if not all, of “cash” compensation (e.g., salary, bonus, commissions, etc.) that would be received by an employee should they become disabled.

Over the last 15 years, however, non-cash compensation has been slowly replacing cash compensation for mid-level to upper level managers and executives. This non-cash compensation has taken the form of stock options, restricted stock units (RSUs) and performance stock units (PSUs). In some cases, this can represent 60-70% of a person's total compensation package. Often times, these mid-level to upper level managers and executives are relying on this compensation to support their families and lifestyles. Yet, current disability insurance plans do not factor in this compensation. When sick or injured, the mid-level to upper level managers and executives will not receive any further grants, and as a result, face a catastrophic financial loss.

What is needed is an assurance equity plan to cover non-cash compensation for injured or sick mid-level to upper level managers and executives.

### SUMMARY OF THE INVENTION

The present invention is related to the field of disability insurance. For example, the invention provides for a disbursement method termed an executive income assurance plan (EIAP®) for equity benefits. An EIAP® Equity Benefit provides coverage for an executive that had previously uninsured compensation.

In one embodiment, the present invention contemplates a method to disburse a disability insurance payment for executive equity compensation, comprising: a) providing: i) a plurality of executive equity compensation sources; and ii) a computer comprising an algorithm; b) calculating a monthly tax-free benefit amount with said algorithm on said computer, wherein said calculating comprises determining an annual intrinsic value of each of said plurality of executive equity compensation sources; and c) executing a financial transaction that disburses said tax-free benefit amount to an executive repeatedly over a plurality of months. In one embodiment, the plurality of executive equity compensation sources are selected from the group consisting of stock options, restricted stock units and performance stock units. In one embodiment, the annual intrinsic value is determined for each year within a lookback period. In one embodiment, the lookback period does not exceed four (4) years. In one embodiment, the calculating further comprises summing each of said annual intrinsic values fur each respective year into a plurality of total grant annual values. In one embodiment, the calculating further comprises averaging said plurality of total grant annual values into a rolling average amount. In one embodiment, the calculating further comprises adjusting said rolling average amount for an average business cycle variation that occurred within said lookback period. In one embodiment, the calculating further comprises multiplying said adjusted rolling average amount by 60% to create an annual tax-free benefit amount. In one embodiment, the calculating further comprises dividing said annual tax-free benefit amount by twelve to create said monthly tax-free benefit amount. In one embodiment, the annual tax-free benefit amount is not a lump sum payment.

In one embodiment, the present invention contemplates a method to invoice a disability insurance premium for executive equity compensation, comprising: a) providing: i) a plurality of executive equity compensation source vesting schedules; and ii) a computer comprising an algorithm; b) calculating an annual premium with said algorithm on said computer using a monthly benefit amount and one of said plurality of equity compensation source vesting schedules; c) executing a financial transaction that invoices a client. In one embodiment, the vesting schedule is selected from the group consisting of a 3-year vesting schedule, a 4 year vesting schedule, a cliff vesting schedule and any combination thereof. In one embodiment, the calculating further comprises said monthly benefit amount is allocated into a plurality of monthly benefit amount tranches based upon an elimination period and a benefit duration of each of said plurality of vesting schedules. In one embodiment, the calculating further comprises adjusting each of said plurality of monthly benefit tranches with a loading factor-specific actuarial rating matrix. In one embodiment, the rating matrix comprises information selected from the group consisting of an executive's age, said elimination period and said benefit duration. In one embodiment, the calculating further comprises applying a census to said rating matrix to calculate a respective premium for each of said plurality of tranches. In one embodiment, the calculating further comprises summing said respective premium into said annual premium. In one embodiment, each of said plurality of executive equity compensation source vesting schedules comprises a plurality of tranches. In one embodiment, each of said plurality of tranches has a different elimination period and a different benefit duration.

In one embodiment, the present invention contemplates a computer readable medium comprising an algorithm comprises a plurality of steps to calculate a disability insurance benefit premium for equity compensation.

### DEFINITIONS

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but also plural entities and also includes the general class of which a specific example may be used lar illustration. The terminology herein is used to describe specific embodiments of the invention, but their usage does not delimit the invention, except as outlined in the claims.

The term “about” or “approximately” as used herein, in the context of any assay measurements refers to +/−5% of a given measurement.

The term “covered compensation” as used herein, refers to what terms an insurer considers for compensation in a benefit calculation for any one particular claim. For example, categories of covered compensation may include, but is not limited to, base compensation, cash bonus, commissions, RSU's, PSU's and stock options.

The term “group long term disability insurance” or “GLTD insurance” as used herein, refers to coverage provided by an employer for the benefit of its employees. An exemplary MD insurance policy can protect an employee from loss of income in the event of an inability to work, for example, due to an illness or an injury. There is usually a monthly benefit cap ranging between approximately $5,000-$20,000 per month but on rare occasion can be even greater. Exemplary categories of GLTD insurance covered compensation may include, but is not limited to, base compensation, cash bonus and/or commissions.

The term, “individual disability insurance” or “IDI” as used herein, refers to a supplemental insurance policy attached to an employer's existing GLTD insurance program. Most often, this is done to provide coverage for those employees with an income exceeding the GLTD benefit cap, or to provide for uncovered income such as a cash bonus. Benefit caps for IDI typically range between approximately $5,000 to $15,000 per month. IDI carriers will not offer disability insurance for income provided by incentive awards including, but not limited to, stock options, restricted stock units or performance stock units.

The terms “elimination period” as used herein, refers to a period of time when an insured has to wait to collect benefits. Typically, elimination periods have a duration ranging between approximately 90-730 days. Oftentimes, the elimination period is referred to as a “deductible” in which an insured will receive no benefit. For example, the shorter the elimination period the more expensive a premium because money is being paid to the insured more quickly.

The term, “benefit period” as used herein, refers to a period for which benefits are paid once a disability occurs. Group and IDI carriers typically have benefit periods that are paid to an age-related upper limit such as 65 or 67. The EIAP® Equity Benefit can also have a benefit period to an age such as 65 or 67, despite other carriers in the market only offering 2 years, 5 years or 10 years for a benefit period.

The term, “replacement ratio” as used herein, refers to a percentage of covered income. Typical plans cover approximately 60% of compensation to a “benefit cap” which is expressed in a fixed dollar amount. An illustrative example would be expressed as “benefits will be paid at 60% (Replacement Ratio) to a maximum benefit of $15,000 per month.”

The term “benefit cap” as used herein, refers to a maximum dollar amount for any particular claim within a particular time period. For example, it may be expressed in a weekly, monthly or annual benefit amount.

The term “rating matrix” as used herein, refers to a compilation of premium rates and loading factors which were actuarially developed based on age, benefit period and elimination period, among other factors. During the calculation process, the algorithm pulls applicable rates from the rating matrix to combine them and create the premium for each insured individual.

The term, “executive” as used herein, refers to a mid-to-upper management corporate position whose compensation is primarily derived, at least in part, from stock options, restricted stock units and/or performance stock units.

The term “premium” as used herein, refers to the cost of insuring any one individual or group.

The term “census” as used herein, refers to a listing of employees with compensation data, which allows performance of an exposure analysis to set coverage levels and pricing.

The term “business cycle” as used herein, refers to a natural rise and hall of economic growth that occurs over a specific time period. For example, according to the National Bureau of Economic Research, there has been 11 business cycles from 1945-2009, which averages out to be 5 years and 10 months per cycle.

The term, “schedule” as used herein, refers to the summary of benefits and premiums for all individuals on a policy, which will not change until a new schedule is issued, usually on each anniversary.

The term “vesting” or “standard vesting” refers to a process where employees earn the right to receive benefits gradually over the course of a period of time. This usually is in equal intervals, but does not have to be. Generally, a vesting process occurs in accordance with a “vesting schedule”.

The term “cliff vesting” as used herein, refers to a process where employees earn the right to receive benefits fully at a specified date, rather than becoming available in increments over a period of time.

The term, “restricted stock units or “RSUs” as used herein, is compensation offered by an employer to an employee in the form of company stock. For example, an employee may not receive the stock immediately, but instead receives it according to a venting schedule and distribution schedule upon remaining with the employer for a particular length of time. Upon vesting, a RSU is considered regular income, and a portion of the shares are sometimes withheld to pay income taxes. The employee receives the remaining shares and can sell them at any time.

The term, “performance stock units or “PSUs” as used herein, is compensation offered by an employer to an employee in the form of company stock. For example, an employee may not receive the stock immediately, but instead receives it according to a vesting schedule and distribution schedule after achieving required performance milestones. Upon vesting, a PSU is considered regular income, and a portion of the shares are sometimes withheld to pay income taxes. The employee receives the remaining shares and can sell them at any time.

The term, “stock price” as used herein, refers to a monetary value of the purchase of the security from a registered stock exchange service.

The term, “strike price” or “exercise price” as used herein, refers to a specified price on an option contract at which an employee can buy the underlying shares.

The term “intrinsic value” as used herein, refers to a monetary difference between the strike price of an option and the stock price of the underlying shares.

The term, “stock option” as used herein, refers to a program where an employee is provided a right to buy a certain number of shares in the employer company at a fixed price, usually for a certain number of years. The price at which an option is provided is called a “strike price” and is usually the “market price” at the time an option is granted. When employees are granted a stock option benefit, if the stock price increases, they may “cash in” by “exercising” (e.g., purchasing) the stock at the lower strike price and then selling the stock at the current market price, leaving the individual with a profit for the difference. This is typically done in one transaction. The executive realizes ordinary income tax treatment if the option is sold within a year of the grant's vesting. If the stock price is less than the strike price, the options are worthless.

The term, “lookback period” as used herein, refers to either the prior 4 fiscal years, or the number of years that the individual has received grants, whichever is smaller.

The term, “monthly benefit” or “stated benefit” as used herein, refers to a benefit amount shown on an individual insurance policy schedule.

### BRIEF DESCRIPTION OF THE FIGURES

FIG. 1 presents a graphical representation of how, current disability insurance standards could only replace 20% of the income of an executive having a combined annual compensation of $900,000.

FIG. 2 presents a graphical representation of how an Executive Insurance Assurance Plan with the Equity Benefit would replace 52% of the income of an executive having a combined annual compensation of $900,000.

FIG. 3 presents an example of conventional vesting schedule payments showing the loss of equity compensation after the time of disability (e.g., 2018/2019).

FIG. 4 presents an example of an EIAP® Equity Benefit vesting schedule showing disbursement of equity compensation after the time of disability (e.g., 2018/2019).

FIG. 5A-B presents an exemplary calculation of benefits in accordance with an executive insurance assurance plan equity benefits plan.

FIG. 5A: Shows the calculation of Year 1 benefits (2017).

FIG. 5B: Shows the calculation of Year 2 benefits (2018).

FIG. 6A-B presents exemplary provided client information used to calculate the EIAP® Equity Benefit.

FIG. 7 presents one embodiment of a benefits duration ratings matrix.

FIG. 8 presents one embodiment of an elimination period ratings matrix.

FIG. 9A-O presents the calculation algorithms in accordance with Examples III-VI.

### DETAILED DESCRIPTION OF THE INVENTION

The present invention is related to the field of disability insurance. For example, the invention provides for a disbursement method termed an executive income assurance plan (EIAP®) for equity benefits. An Equity Benefit provides coverage for an executive that had previously uninsured compensation.

### I. Conventional Equity Benefit Disability Plans

Current disability plans usually take the form of traditional group long term disability (GLTD) insurance, which usually covers salary and sometimes commission and cash bonus. In most cases GLTD programs protect between $100,000 to $400,000 of income at a 60% replacement ratio. Additionally, individual disability insurance (IDI) can cover cash compensation of another $100,000 or $300,000. So usually, companies can, but may choose not to, cover up to $700,000 of compensation for their employees using US-based GLTD and IDI, although in some rare cases this number can be higher.

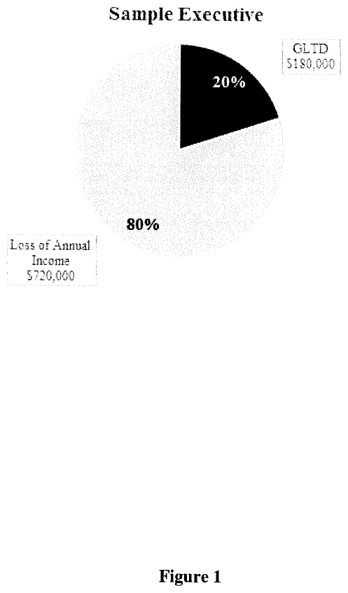

The insurance industry has ignored the disability benefit shortfall for mid-high level executives who are compensated by stock options, RSUs and PSUs (e.g., equity compensation). See, FIG. 1. Due to a perceived overall negative risk balance, the GLTD and IDI insurance companies have not been willing to include equity-based compensation for disability insurance coverage. Although it is not necessary to understand the mechanism of an invention, it is believed that these insurers cannot quantify the risk because of a lack of understanding as to how to structure the benefits package. It is further believed that disability insurance for the equity compensation would expose the insurance company to a moral hazard risk; for example, where an insured executive could be better off financially in terms of net after tax income on a disability insurance claim rather than remaining at work. In addition, the GLTD and IDI are also inflexible in that they do not adjust benefits each year so insuring equity compensation, which does fluctuate in value from year to year, would not be feasible to be covered compensation under the rigid structure of GLTD and IDI.

These risks are, in part, due to the way the insurers structure their benefits. Furthermore, the risks include an inability to recalculate or adjust benefits year to year to account for unpredictable changing stock prices and/or adjustments in equity awards. In conventional disability insurance plans, once a risk is declared the insurers cannot adjust coverage based upon unforeseen future events. This inflexibility has hampered the industry's ability to adjust insurance plans to accommodate for' a myriad of factors including, but not limited to, modifications in grant value or stock prices. One disadvantage of conventional insurance plans is that this type of risk adjustments fur future forecasting would require a complex calculation and much higher administrative costs and therefore would reduce margins. The industry also views this market as far too narrow and would involve a complicated transaction, which most brokers would find difficult to understand and would likely not adopt.

One insurance provider has attempted to create a potential solution to insure equity benefits by adapting an existing product which provides a very short-term solution. This approach, however, does not adequately quantify the magnitude of the need. In this approach, a provider underwrites one time and provides a nontraditional lump-sum benefit of up to 5× the average of the last 3 years of traditional options. Disadvantages of this lump-sum approach include, but are not limited to, that it does not adjust year-to-year to allow for changing grant amounts and requires full medical underwriting. In addition, lump-sum payout products leave the insurer exposed to an increased moral hazard risk when market conditions deteriorate. Furthermore, the lump-sum payout product does not cover restricted stock units or performance stock units. In addition, the product only provides a lump sum for a limited period of one to five years and does not address the long-term financial exposure for an individual requiring long-term disability coverage. Clearly, a lump-sum payout program is not a long-term solution in order to alleviate a catastrophic financial loss for an individual facing long term disability. A one-time payment only offers some assistance in the beginning. For example, after two (2) years the total income replacement ratio (e.g., total disability benefits received/total annual income) drops below 50% and after six (6) years the total income replacement ratio drops below 30%. See, Table 1.

TABLE 1
Reduction In Annual Total Income Replacement Ratio For Lump-Sum Payouts
Scenario 1:

| | Average | | |
|---|---|---|---|
| | Annual | Disability | |
| | Income | Insurance | |
| Cash Compensation | $400,000 | $180,000 | GLTD affers 60% replacement to $15,000 per month ($180,000 per year) |
| RSU's | $250,000 | — | Nothing currently available in the market to insure this income |
| PSU's | $200,000 | — | Nothing currently available in the market to insure this income |
| Options | $150,000 | $750,000 | One provider's solution. This is a one time payment made 1-5 years after disability begins |
| | $1,000,000 | | |

Long-Term Schedule of Payments - One Provider's Solution

| | Year 1 | Year 2 | Year 3 | Year 4 | Year 5 | Year 6 | Year 7 | Year 8 | Year 9 | Year 10 | . . . | Year 13 |
|---|---|---|---|---|---|---|---|---|---|---|---|---|
| Cash Com- | $180,000 | $180,000 | $180,000 | $180,000 | $180,000 | $180,000 | $180,000 | $180,000 | $180,000 | $180,000 | . . . | $180,000 |
| pensation | | | | | | | | | | | | |
| RSU's | $0 | $0 | $0 | $0 | $0 | $0 | $0 | $0 | $0 | $0 | . . . | $0 |
| PSU's | $0 | $0 | $0 | $0 | $0 | $0 | $0 | $0 | $0 | $0 | . . . | $0 |
| Options | $750,000 | $0 | $0 | $0 | $0 | $0 | $0 | $0 | $0 | $0 | . . . | $0 |
| Total | $930,000 | $180,000 | $180,000 | $180,000 | $180,000 | $180,000 | $180,000 | $180,000 | $180,000 | $180,000 | . . . | $180,000 |
| % of | 93% | 18% | 18% | 18% | 18% | 18% | 18% | 18% | 18% | 18% | . . . | 18% |
| Normal | | | | | | | | | | | | |
| Income | | | | | | | | | | | | |
| Replaced | | | | | | | | | | | | |
| in that year | | | | | | | | | | | | |
| % of | 93% | 56% | 43% | 37% | 33% | 31% | 29% | 27% | 26% | 26% | . . . | 23% |
| Normal | | | | | | | | | | | | |
| Income | | | | | | | | | | | | |
| Replaced | | | | | | | | | | | | |
| from the | | | | | | | | | | | | |
| start of the | | | | | | | | | | | | |
| disability | | | | | | | | | | | | |

### II. EIAP® Equity Benefit Disbursement Method

As explained above, there is a need in the executive disability insurance market that has not been addressed by any current disability insurance plan. In one embodiment, the present invention contemplates an executive disability insurance disbursement method that solves the disadvantages of current plans and addresses concerns relative to potential moral hazards. In one embodiment, the present invention contemplates a method for disability insurance underwriting that incorporates income generated from employee stock options, restricted stock units and/or performance stock units. In one embodiment, the underwriting method determines disability benefits. In one embodiment, the disability benefits are long-term disability benefits. In one embodiment, the underwriting method insures lost income from future equity income variations. In one embodiment, the EIAP® Equity Benefit pays in monthly benefits, alongside the monthly benefits for cash compensation, thereby making an integrated and seamless payment schedule.

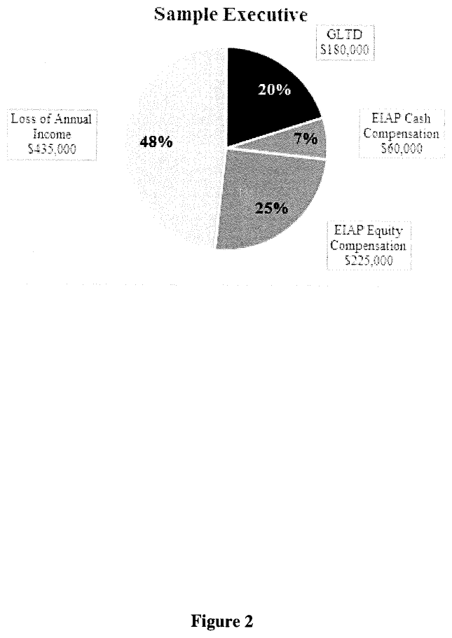

The EIAP® Equity Benefit disbursement method as described herein solves the problem of catastrophic loss of income following a disability, which was previously only covered under conventional insurance plans as shown in FIG. 1. FIG. 2 shows the income replacement from the EIAP® Equity Benefit, which includes multiple equity components, with various vesting schedules. See, FIG. 2. In summary, the covered employee would receive:
Total pre-tax income prior to a disability: $900,000.
Total annual disability benefit: $465,000.

The financial position of the disabled executive has improved significantly. For example, the executive now has 52% of his/her income replaced instead of 20% as allowed by conventional disability insurance plans.

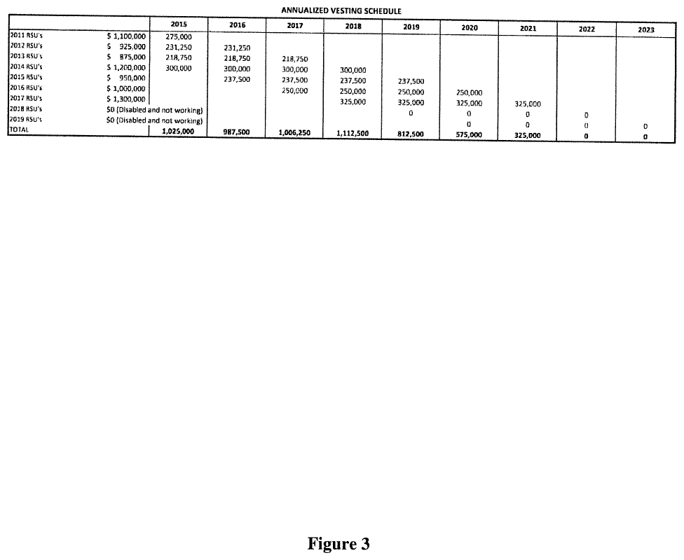

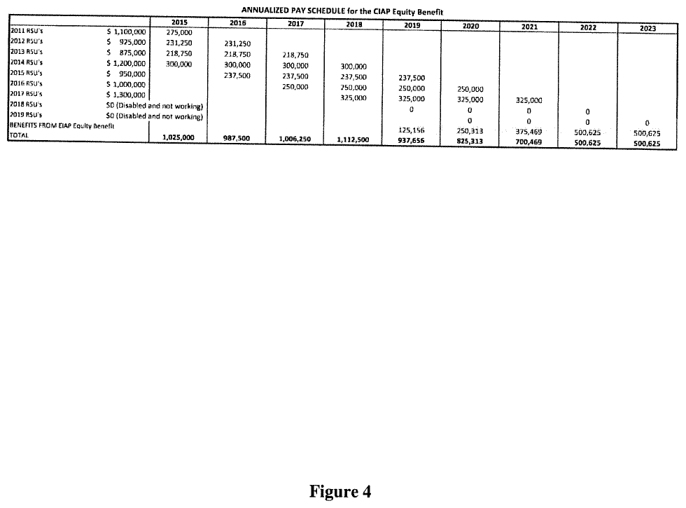

As discussed in more detail below, the EIAP® Equity Benefit disbursement method described herein is significantly more favorable to the insureds as compared to the other provider's lump sum benefit. For example, a comparison is provided between the a conventional insurance payout and an EIAP® Equity Benefit disbursement payout given the same income information. A conventional schedule shows an excess of “% of normal income replaced from the start of the disability” in Years 1 and 2, but the percent replacement quickly tapers off*and slumps to less than 30% after the 7^{th} year of disability. FIG. 3. In contrast, an EIAP® Equity Benefit disbursement schedule shows a relatively stable income after Years 1 and 2 until the 7^{th} year of disability. FIG 4. The stabilizing effect of an EIAP® disbursement schedule is more clearly seen as a stable replacement ratio throughout a 15 year coverage period that is expected to continue through the duration of the disability or the maximum benefit period. Table 1. This is an improved long-term solution for disabled executives. Not shown on this example is a scenario where the individual was insured under a conventional plan but received a higher amount of options in later years. Under such a conventional plan, this would increase the average annual income for the individual, but would not change the benefit for options. In one embodiment, the EIAP® Equity Benefit disbursement method takes into account changes in stock grant amounts and valuation each year and adjusts benefits to keep in line with the most up-to-date income.

### A. Overview

Equity compensation granted to executives often vest, or pay out over a period of time. Therefore, these grants are actually paid out years after they were initially granted (e.g. 3 years later, 4 years later). For example, if $1,000,000 is granted in year 1, and that stock vests 33.333% each year over 3 years, $333,333 will be paid in year 1, 2, and 3. Each year an executive will receive partially vested grants from previous years, summing what seems like a full year's worth of grants. See, FIG. 3. However, if an individual were to become disabled, those grants will stop. Unlike cash compensation where loss of income is seen almost immediately, portions of leftover stock grants will still become available each year during the disability but will decrease each year due to grants becoming fully vested (i.e. the grants no longer pay out). In one embodiment, the present invention contemplates a method for determining executive disability insurance that incorporates a vesting schedule into the determination of the benefit payout or disbursement. Although it is not necessary to understand that mechanism of an invention, it is believed that by incorporating a vesting schedule into benefit payout determination, an individual is not over-insured in the first few years of disability while grants are still expiring.

In one embodiment, the present invention contemplates a method for determining executive disability insurance where equity benefits arc paid after an initial elimination period at a percentage based on the company's vesting. See, FIG. 4. In one embodiment, the equity benefits include, but are not limited to, stock options, RSU contract(s) and/or PSU contract(s). In one embodiment, the equity benefits are listed in an individual policy schedule. In one embodiment, the determining further comprises vesting schedules including, but not limited to, 3-year vesting, 4-year vesting, and/or cliff vesting. In one embodiment, the method incorporates all vesting schedules simultaneously. In one embodiment, the vesting schedule comprises a combination of cliff vesting and standard vesting. In one embodiment, the vesting schedule comprises a combination of a variety of different equity benefits. In one embodiment, the vesting schedule comprises a duration of any length of time. In one embodiment, the vesting schedule comprises a combination of different equity benefits and a duration of any length of time. In one embodiment, the vesting schedule comprises a custom schedule. In one embodiment, the custom schedule incorporates 10% of Year 1 equity compensation, plus 10% of Year 2 equity compensation, plus 40% of Year 3 equity compensation and plus 40% of Year 4 equity compensation.

Although it is not necessary to understand the mechanism of an invention, it is believed that there are a substantial number of different scenarios of which to combine the vesting schedules for Equity Compensation at a company. In one embodiment, the vesting schedule is a standard vesting schedule (i.e. benefit vests in a percentage over time) comprises at least two different types.

In one embodiment, the standard vesting schedule type comprises an equal part vesting percentage. For equal part vesting, the total grant vests equally over a number of years. Examples of this seen in the marketplace are 2-year vesting (50% each year), 3-year vesting (33.3% each year), 4-year vesting (25% each year), 5-year vesting (20% each year), 6-year vesting (16.6% each year) and 7-year vesting (14.28% each year). In theory, the duration of the vesting could be even longer than 7 years if the company wishes.

In one embodiment, the standard vesting schedule type comprises a varied vesting percentage. For varied vesting percentage, there are almost an infinite number of combinations. For a 2-year vesting, the combinations could include: 25%, 75%; 10%, 90%; 30%, 70%; and onward with any combination of percentages totaling 100% over the 3 years. For a 3-year vesting, the combinations could include 25%, 25%, 50%; 10%, 20%, 70%; 20%, 30%, 50%; and onward with any combination of percentages totaling 100% over the 3 years. For a 4-year vesting, the combinations could include: 10%, 10%, 40%, 40%; 20%, 20%, 30%, 30%; 10%, 2.0%, 30%, 40%; and onward with any combination of percentages totaling 100% over the 4 years, For a 5-year vesting, the combinations could include: 15%, 15%, 20%, 25%, 25%; 5%, 10%, 15%, 35% 35%; 10%, 10%, 10%, 20%, 50%; and onward with any combination of percentages totaling 100% over the 5 years.

In one embodiment, the vesting schedule is a cliff vesting schedule. In one embodiment, 100% of the grant becomes available at a future date. In one embodiment, the cliff vesting schedule further comprises an elimination (waiting) period. In one embodiment, the elimination period includes, but is not limited to, 1 year, 2 years, 3 years, 4 year, 5 years, 6 years, and/or 7 years. In theory, the duration of the vesting could be even longer than 7 years if the company wishes.

One of skill in the are will recognize that the above described vesting schedules are not limiting or a complete list but exam lilies at least some schedules that may be seen in the marketplace. Even so, using the above described twenty-five (25) vesting schedules, coupled with the knowledge in the art of other different schedules already incorporated into RSU's, PSU's and Option grants, there are at least 15,625 different combinations of schedules that could be used on any one case (e.g., 25×25×25).

Within each vesting schedule as contemplated herein, there is not only one rating matrix that is used. The vesting schedule is only one factor in determining the rating matrix; other factors include the underlying Elimination Period and underlying Benefit Duration. For example, the rating matrix for a standard equal part 4-year vesting schedule with a 180-day underlying wait, would differ completely from a rating matrix for a standard equal part 4-year vesting schedule with a 365-day underlying wait. Assuming only the 3 most common Elimination Periods (90-day, l 80-day and 365-day) and 3 common Benefit Durations (10-year, 20-year, To Age 65), each vesting schedule has 9 possibilities for a rating matrix. Applying these 9 possibilities to the 26 vesting schedules for each of the three types of Equity Benefits, leaves 11,390,625 different combinations of rating matrices that may have to be used on any one case (225×225×225).

As discussed below, the present invention contemplates an underwriting process. In one embodiment, the present method contemplates an underwriting process comprising of at least two calculation algorithms. In one embodiment, the calculation algorithm determines a benefit amount. In one embodiment, the calculation algorithm determines a premium. In one embodiment, the calculation algorithms are cumulative. In one embodiment, the calculation algorithms are performed in groups of 50-500 at a time. In one embodiment, the calculation algorithm comprises a plurality of algorithms. In one embodiment, the underwriting process is performed by a computer.

### B. Benefit Amount Calculation Algorithm

In one embodiment, the present invention contemplates a method of calculating a benefit amount. In one embodiment, the method calculates an intrinsic value, or fair market value, of each equity grant for each allowed year of a lookback period. In one embodiment, the lookback period is four (4) allowed years. In one embodiment, the lookback period is a number of allowed years ranging between zero (0) years and three (3) years from which an equity grant was provided.

In one embodiment, the method comprises calculating an annual intrinsic value, wherein each grant received in a specific year is multiplied by their respective individual grant intrinsic value and summed together. In one embodiment, the summed individual grant intrinsic values is a total grant annual value for each allowed year. In one embodiment, the method further comprises calculating a rolling average amount of the total grant values over the respective number of allowed grant years (e.g., not greater than four). In one embodiment, the method further comprises, calculating a rolling average amount adjustment by a percentage that reflects the average business cycle variation within the lookback period. Although it is not necessary to understand the mechanism of an invention, it is believed that the risk of encountering a moral hazard is reduced by adjusting the rolling average amount to reflect the business cycle. In one embodiment, the method further comprises calculating an annual stated benefit amount by multiplying the adjusted rolling average amount by 60%. Although it is not necessary to understand the mechanism of an invention it is believed that a sixty percent (60%) reduction in adjusted rolling average amount is equivalent to a tax-free industry standard replacement ratio. In one embodiment, the method further comprises calculating a monthly benefit amount by dividing the annual stated benefit amount by twelve (12). Although it is not necessary to understand the mechanism of an invention, it is believed that the monthly benefit amount provides one of the bases for a premium calculation. Although it is not necessary to understand the mechanism of an invention, it is believed that a benefit amount calculation is completed again each year for each individual.

### C. Premium Calculation Algorithm

In one embodiment, the present invention contemplates a method calculating a premium amount. In one embodiment, the method factors in, but is not limited to; i) an elimination period for the insured portion of compensation (this can differ for each form of compensation); ii) a benefit duration for the insured portion of compensation (this can differ for each form of compensation); iii) a vesting type for the insured portion of compensation (this can differ for each form of compensation); and iv) a vesting duration for the insured portion of compensation (this can differ for each form of compensation). Although it is not necessary to understand the mechanism of an invention, it is believed that the underwriting process of the Executive income Assurance Plan® Equity Benefit described herein can adapt to any variation of vesting schedule including, but not limited to, any length standard vesting, any length cliff vesting, unevenly distributed vesting, and any combination of length and type.

In one embodiment, the calculating of a premium comprises considering a standard vesting schedule. In one embodiment, a standard vesting schedule pays out an even percentage of the benefit amount over a three (3) four (4) year period. In one embodiment, the standard vesting schedule is four (4) years. In one embodiment, the vesting schedule comprises annual 25% vestment of the total benefit amount in each of the four (4) years.

In one embodiment, the method for calculating a premium takes into account an elimination period. For example, an elimination period may be 180 days (6 months). In one embodiment, the calculating further comprises an underlying benefit duration. For example, an underlying benefit duration may be twenty (20) years. In one embodiment, the calculating further comprises a monthly benefit amount. For example, a monthly benefit amount may be $10,000. By way of example, if 25% of the total benefit amount is vested in each year of a four (4) benefit duration, the full monthly benefit would be divided into 4 tranches—$2,500 each. Although it is not necessary to understand the mechanism of an invention, it is believed that each tranche has a different elimination period and different benefit duration in order to account for the vesting schedule. In this example, it is believed that: i) Tranche 1 may have an elimination period of 1.5 years (6 months to qualify for LTD benefits, plus one year of vesting time) and may have a 19-year maximum benefit duration, which is one year less than for the cash compensation due to the additional time taken into account for vesting; ii) Tranche 2 may have a 2.5-year elimination period and 18-year maximum benefit duration; iii) Tranche 3 may have a 3.5 year elimination period and 17-year maximum benefit duration; and iv) Tranche 4 may have a 4.5 year elimination period and 16 ear maximum benefit duration.

In one embodiment, the present invention contemplates a method of calculating a premium wherein each tranche is calculated separately using a rating matrix. In one embodiment, the rating matrix factors in, but is not limited to, an individual's age, an elimination period and a benefit duration, Due to the different assumptions for each tranche, a different rating matrix is constructed for each tranche. In one embodiment, the calculating further comprises applying each matrix to the census to calculate a respective premium for each of the several tranches. In one embodiment, the method further comprises summing each of the four separate premiums into a singular, cumulative annual premium. In one embodiment, the calculating is repeated each year to determine a revised benefit and premium.

While the above example used a standard 4-year vesting schedule, one of skill in the art would realize that a similar process may be used to calculate a 3-year vesting schedule or any other vesting schedule length. Briefly, for a three (3) year vesting schedule, instead of four (4) 25% tranches, the method would employ three (3) 33.333% tranches. Similarly, for schedules that vest in different percentages each year (e.g. 10% Year 1, 10% Year 2, 40% Year 3, 40% Year 4) the tranches would reflect the different percentages and then would be priced according to a pricing matrix. Although it is not necessary to understand the mechanism of an invention, it is believed that the method accommodates an unlimited number of different vesting schedules, and can adapt to each one individually.

In one embodiment, the present invention contemplates a method of calculating premium taking into account cliff vesting. In one embodiment, cliff vesting comprises an elimination period in between a benefit grant and an eventual benefit payout. In one embodiment, the elimination period ranges between three (3)-four (4) years. In one embodiment, cliff vesting results in the entire benefit amount becoming fully vested at the end of the elimination period. The following example uses: i) a 3-year cliff vesting schedule; ii) a 80 day (6 month) elimination period; iii) a twenty (20) year benefit duration; and iv) a $10,000 monthly benefit. These parameters result in an rating matrix comprising a 3.5-year elimination period and a 17-year benefit duration. As described above, these rating matrix parameters may be used to calculate an annual premium for this portion of the equity benefit.

In one embodiment, the present invention contemplates a method further comprising a combination of at least two vesting types for different portions of the equity benefit. In one embodiment an RSU equity benefit has cliff vesting. In one embodiment, a stock option equity benefit has standard vesting. Although it is not necessary to understand the mechanism of an invention, it is believed that each benefit vesting schedule is evaluated separately for each portion of the equity benefit, as well as a separate calculation of premiums using an established protocol fur each particular vesting type.

### D. Taxation Treatment

Although it is not necessary to understand the mechanism of an invention, it is believed that most corporate executives report equity benefits as ordinary income by cashing out vested stocks. It is further believed, that by using the above described 60% replacement ratio for benefits calculation, the benefits paid from the method described herein are tax-free because the premiums are paid with after-tax dollars.

### EXAMPLES

### Example I

### Annual Financial Loss Due to Uninsured Equity Income

This example is based upon an executive that earns $400,000 a year in base and bonus compensation and then receives $250,000 of Restricted Stock Units and $250,000 of Performance Stock Units each year. The company has ° LTD insurance coverage of $15,000 per month ($180,000 per year), which currently only replaces 20% of the employee's income. This is opposed to an industry standard where disability insurance should cover up to 60% of income. See, FIG. 1.

The executive's exposed income is illustrated below:

| | |
|---|---|
| Base and Bonus Compensation: | $400,000 |
| RSU Compensation: | $250,000 |
| PSU Compensation: | $250,000 |
| Total income prior to a disability: | $900,000 |
| Total annual disability benefit: | $180,000 |

This example illustrates how a mid-to-high level executive receives far less than 60% income replacement provided by the company-sponsored standard disability insurance plans for both non-executive and executive employees.

### Example II

### Executive Income Assurance Plan® Equity Benefit Calculation

This example provides a representative implementation of an Executive Income Assurance Plan Equity Benefit as contemplated herein. The example is based upon a hypothetical executive, Mr. John Smith.

### Benefit Calculation—Year 1

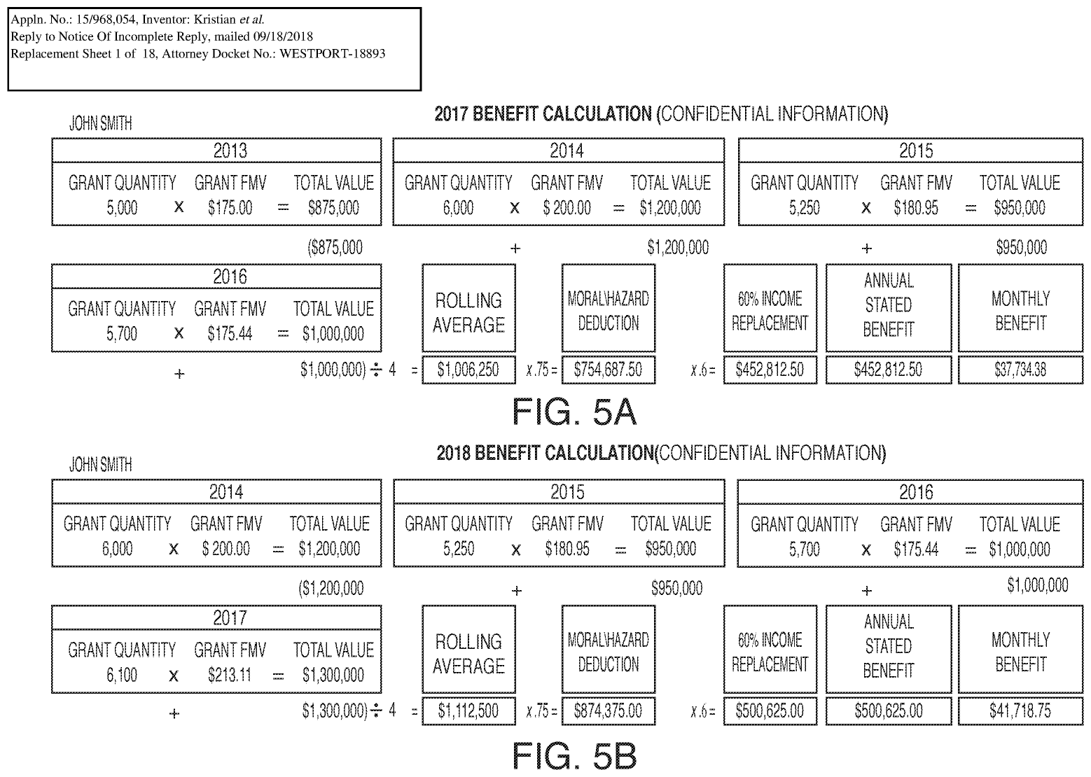

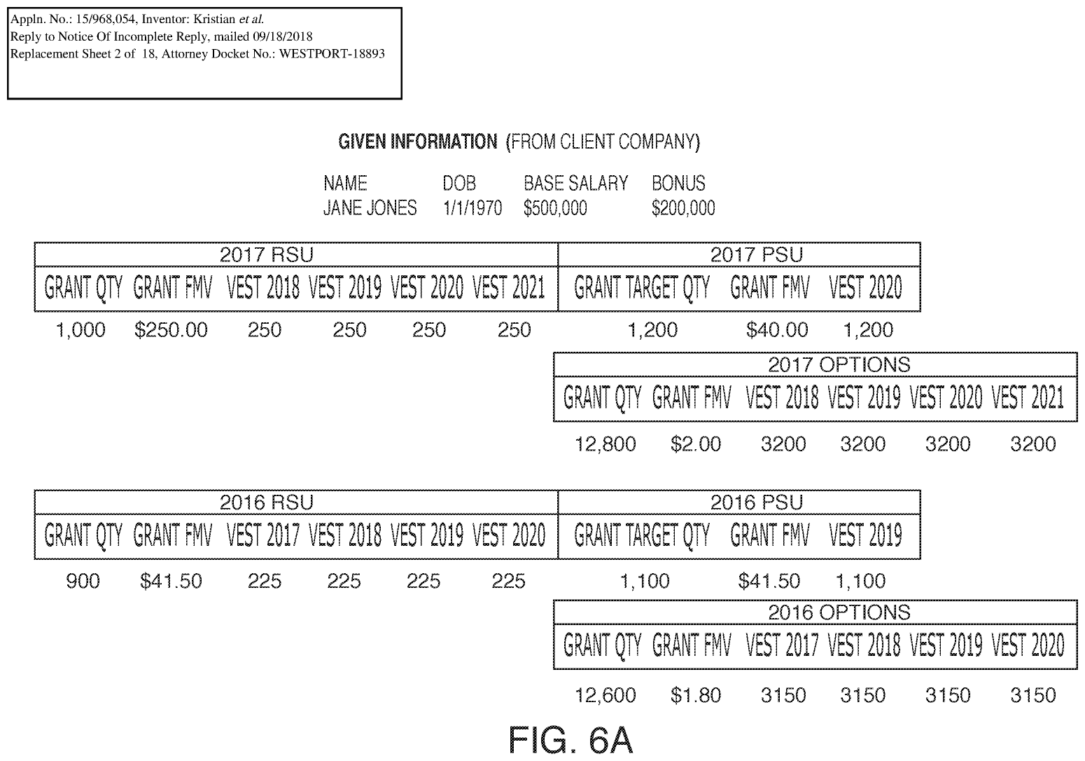

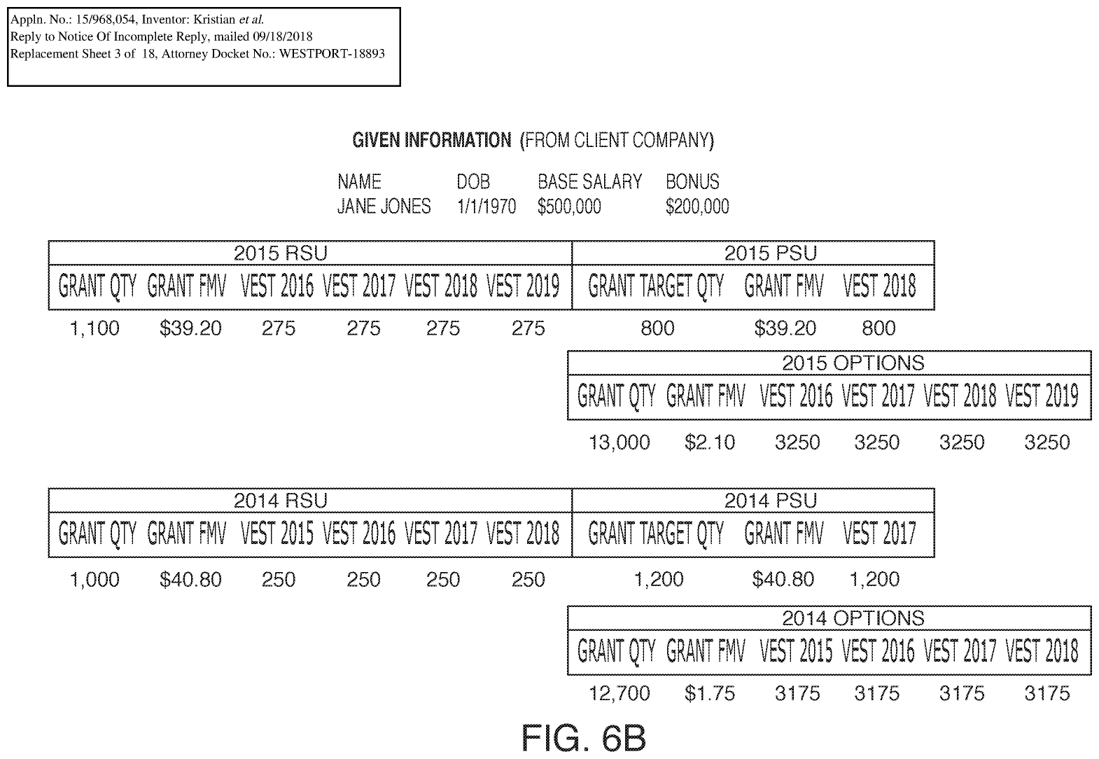

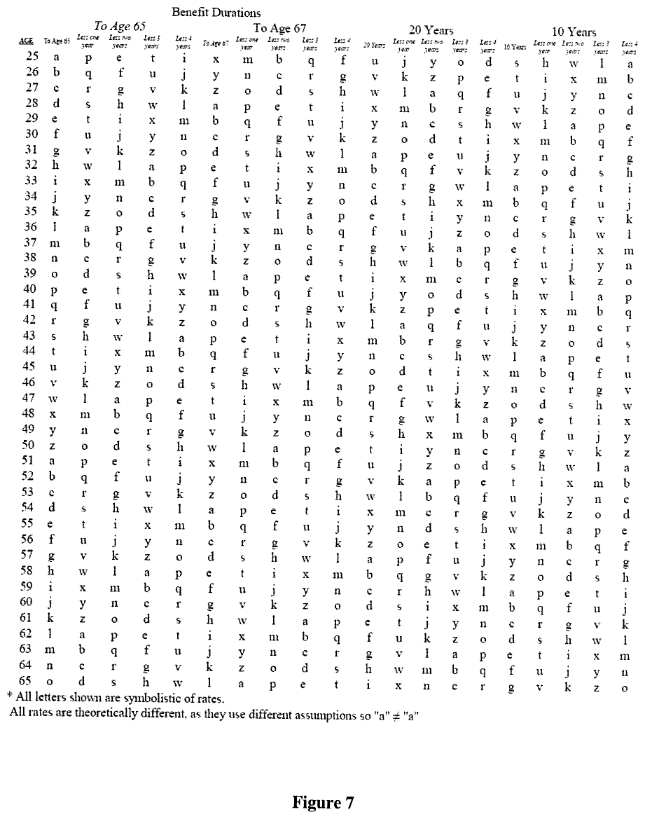

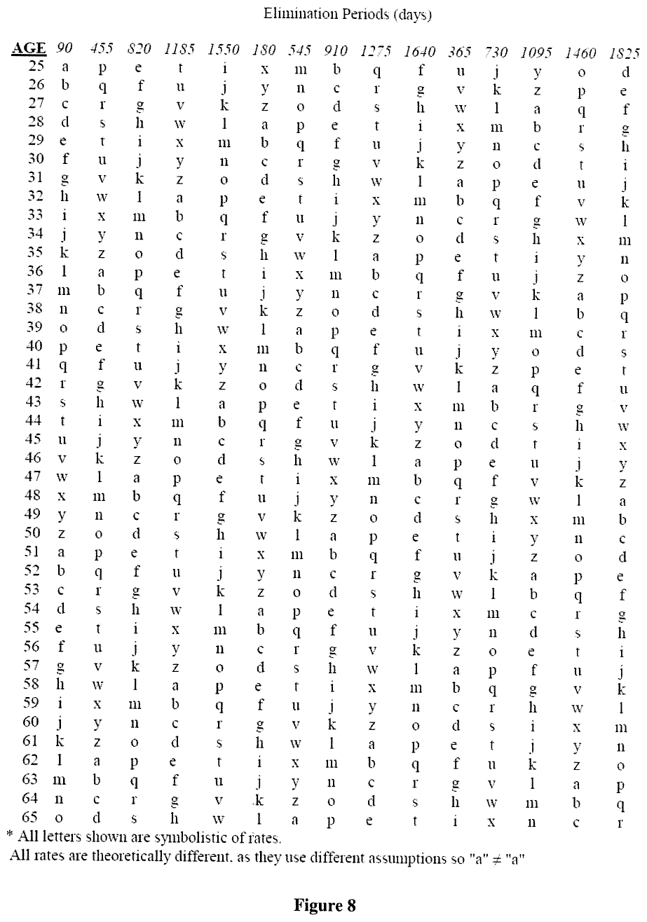

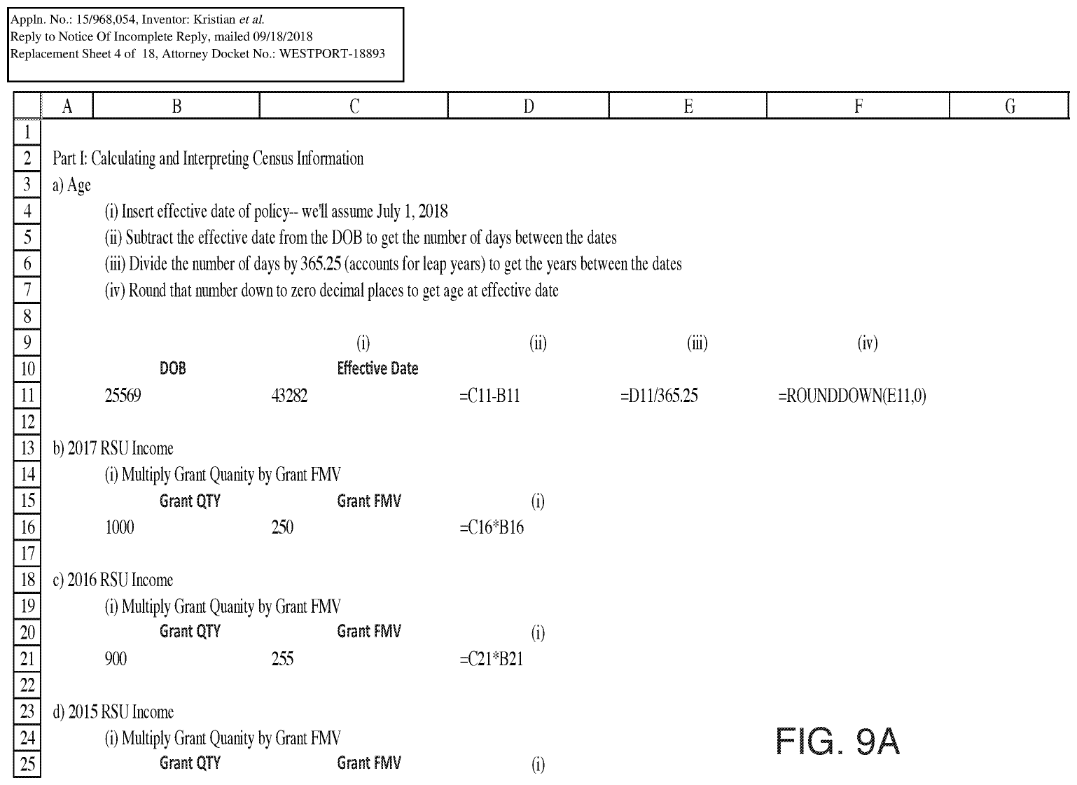

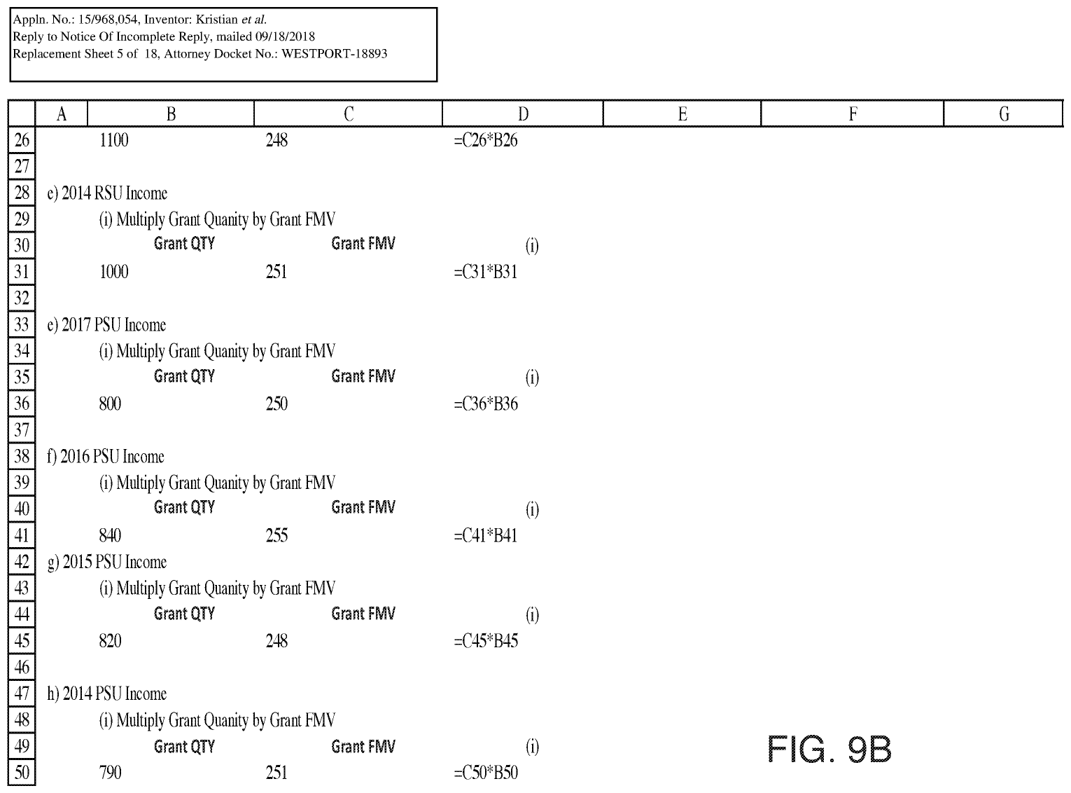

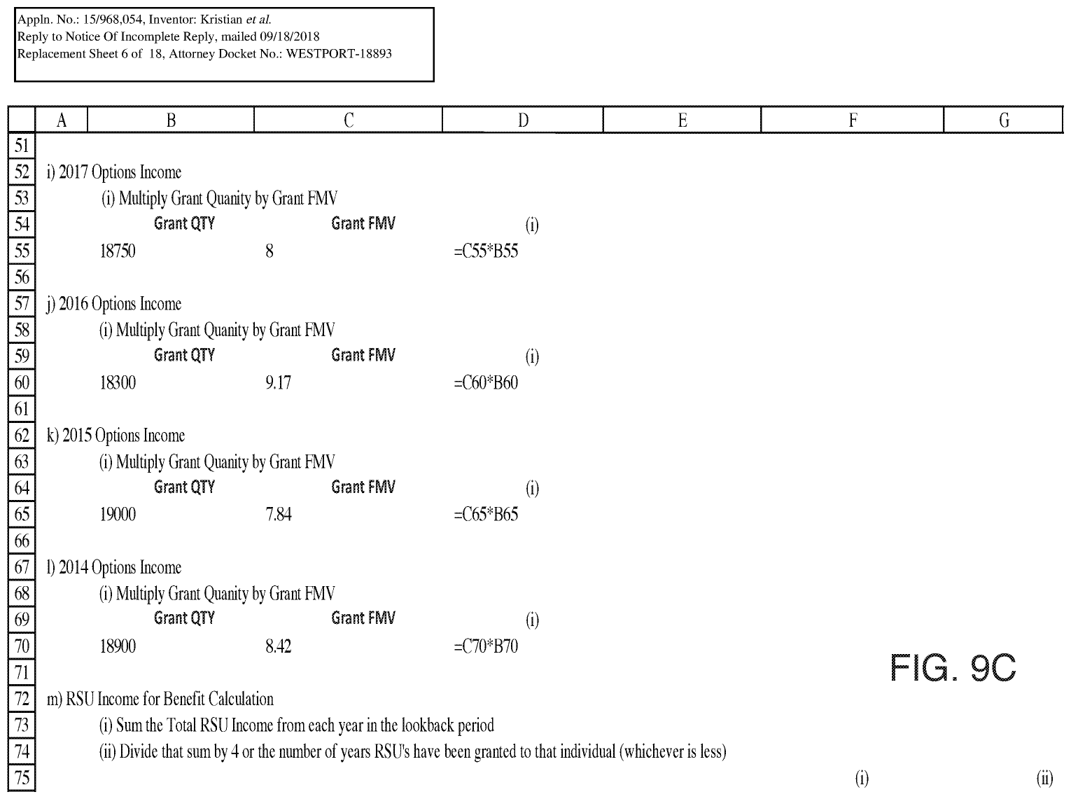

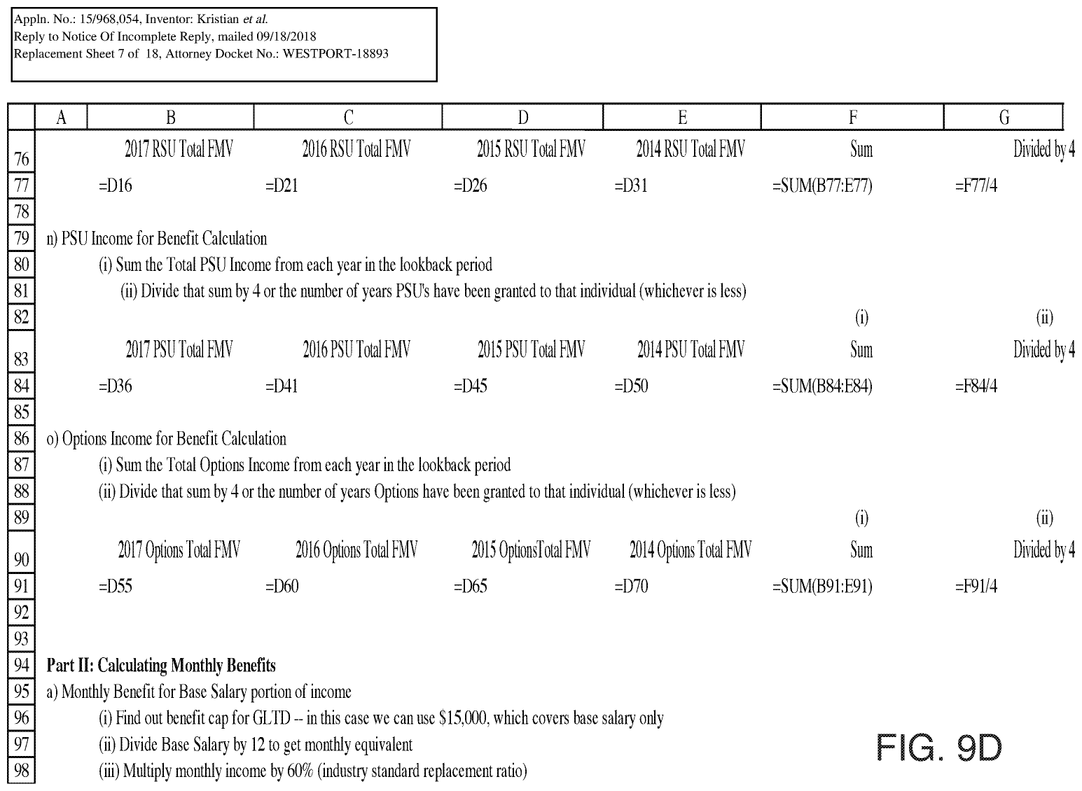

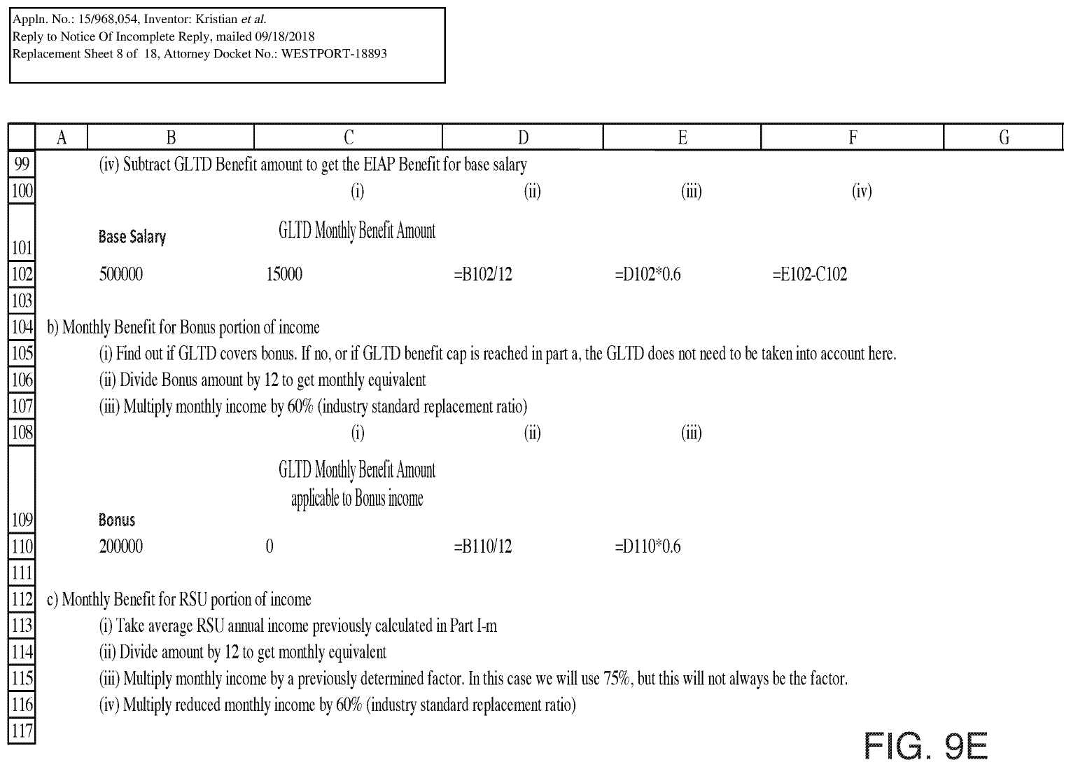

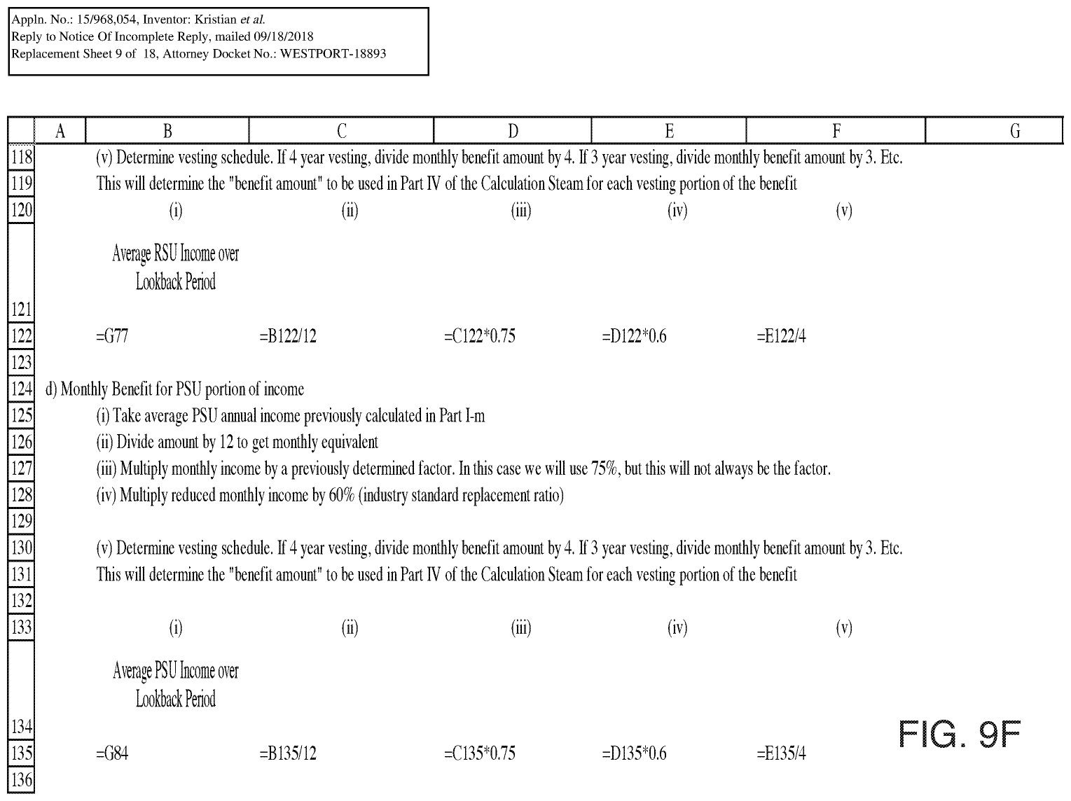

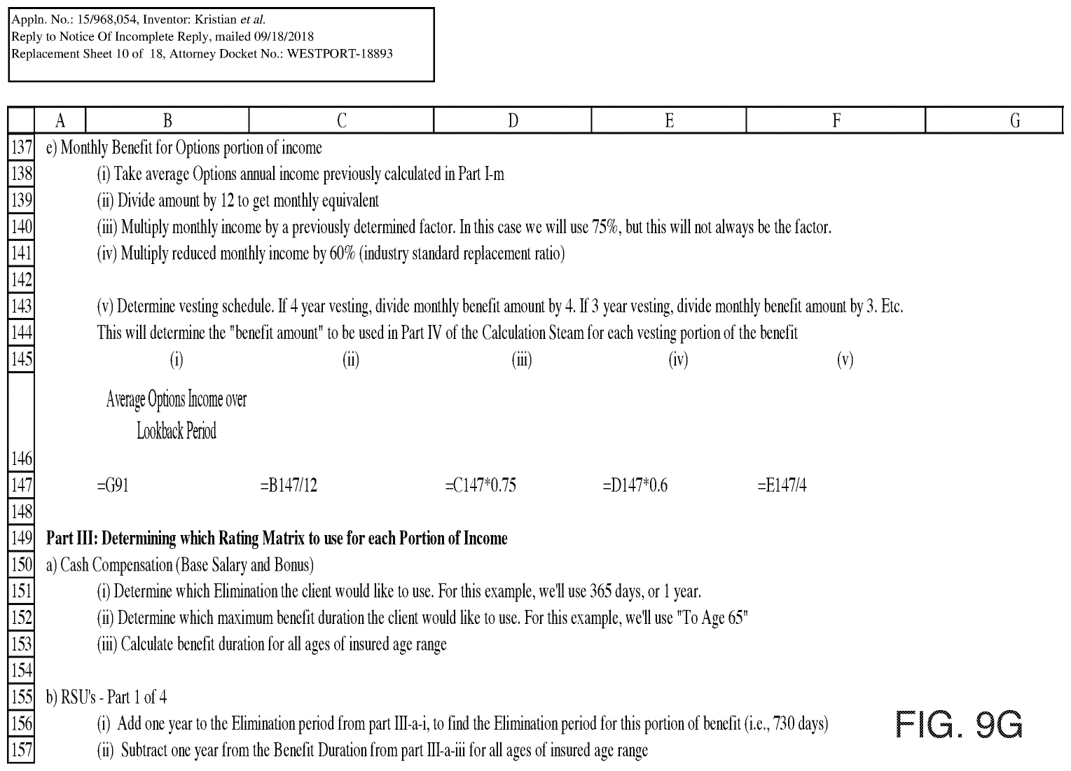

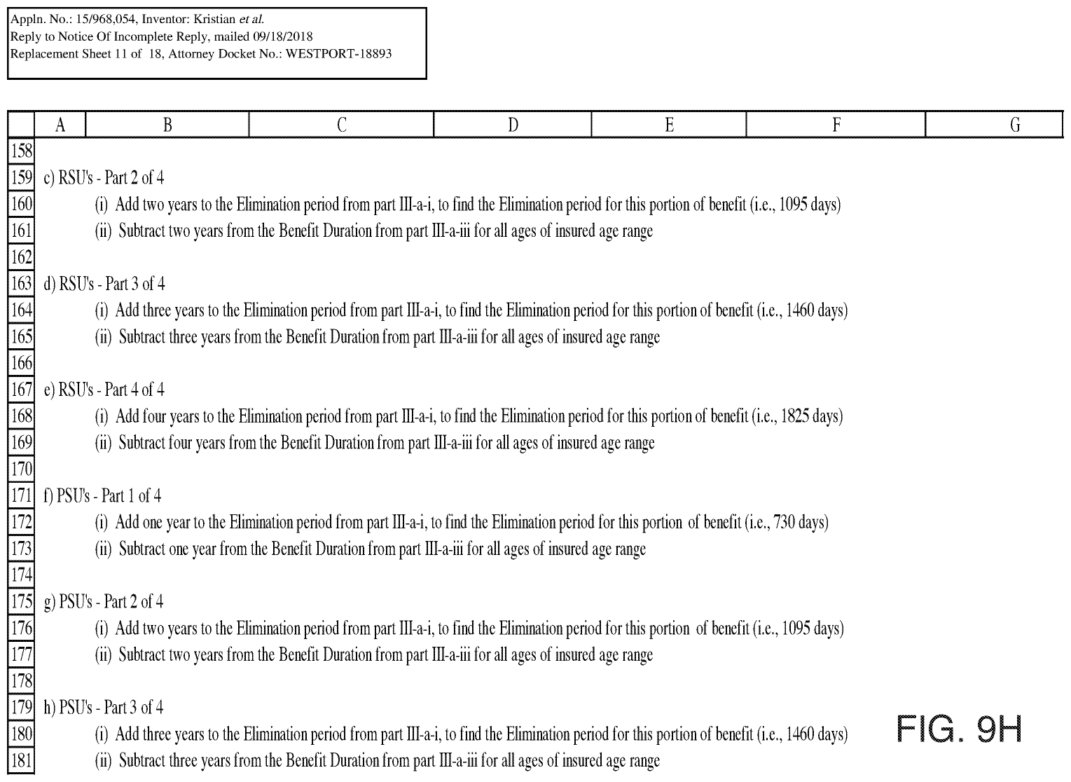

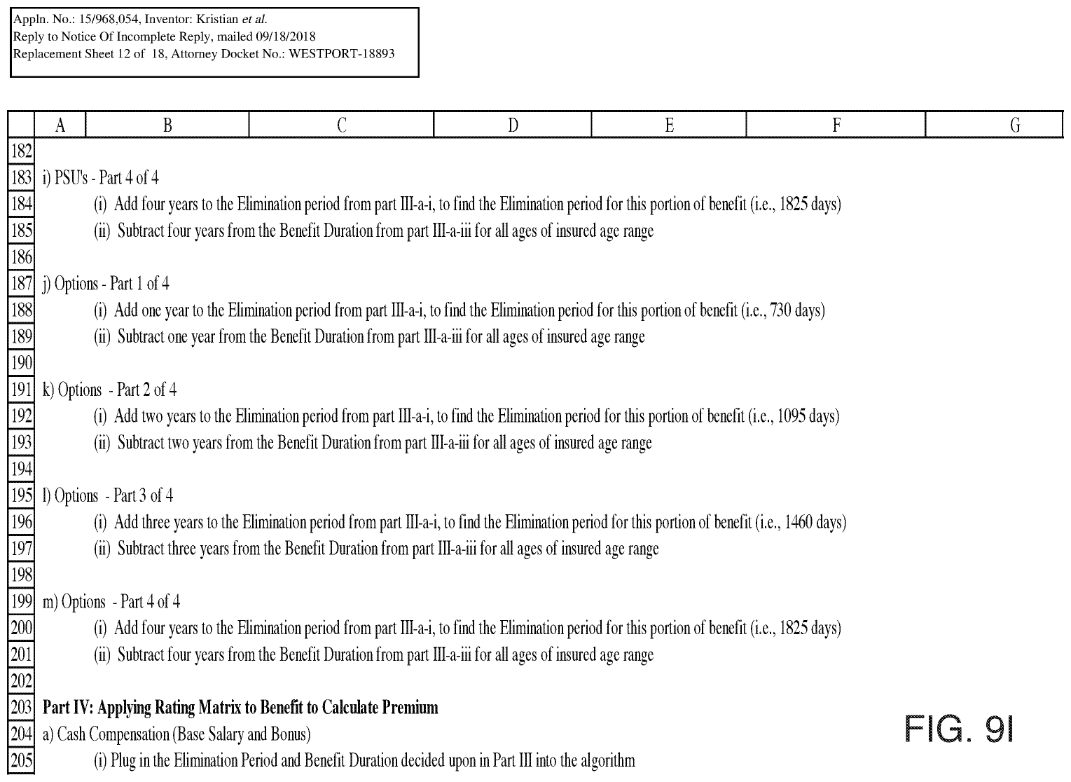

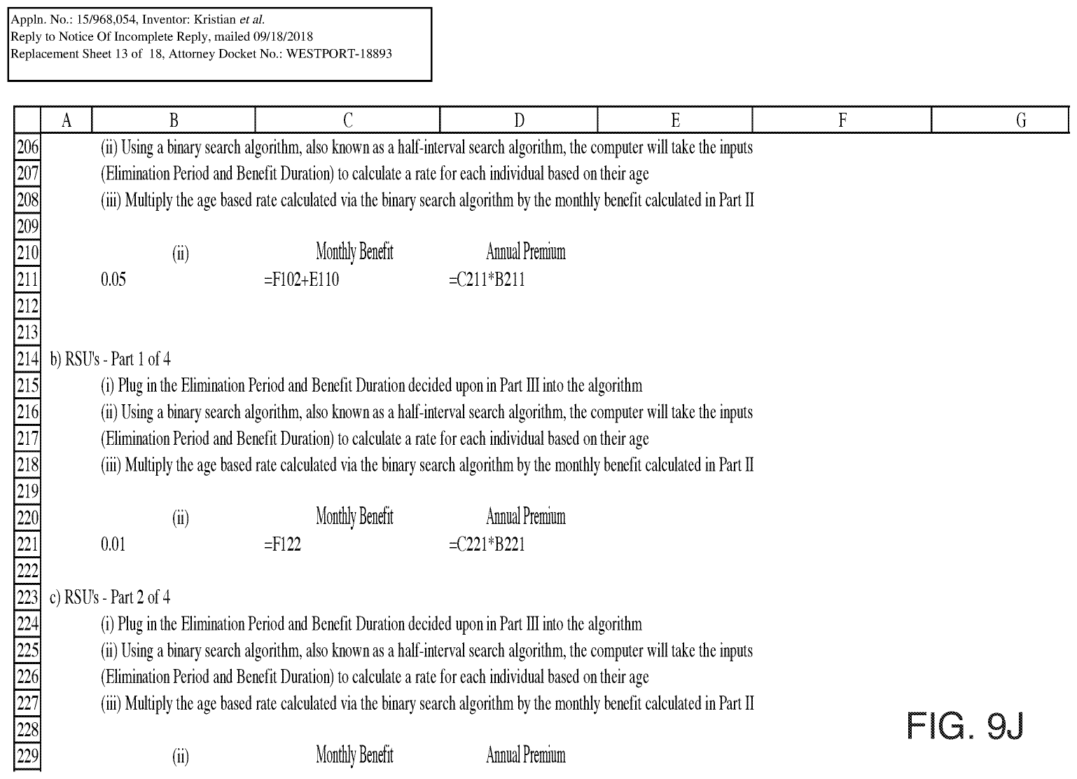

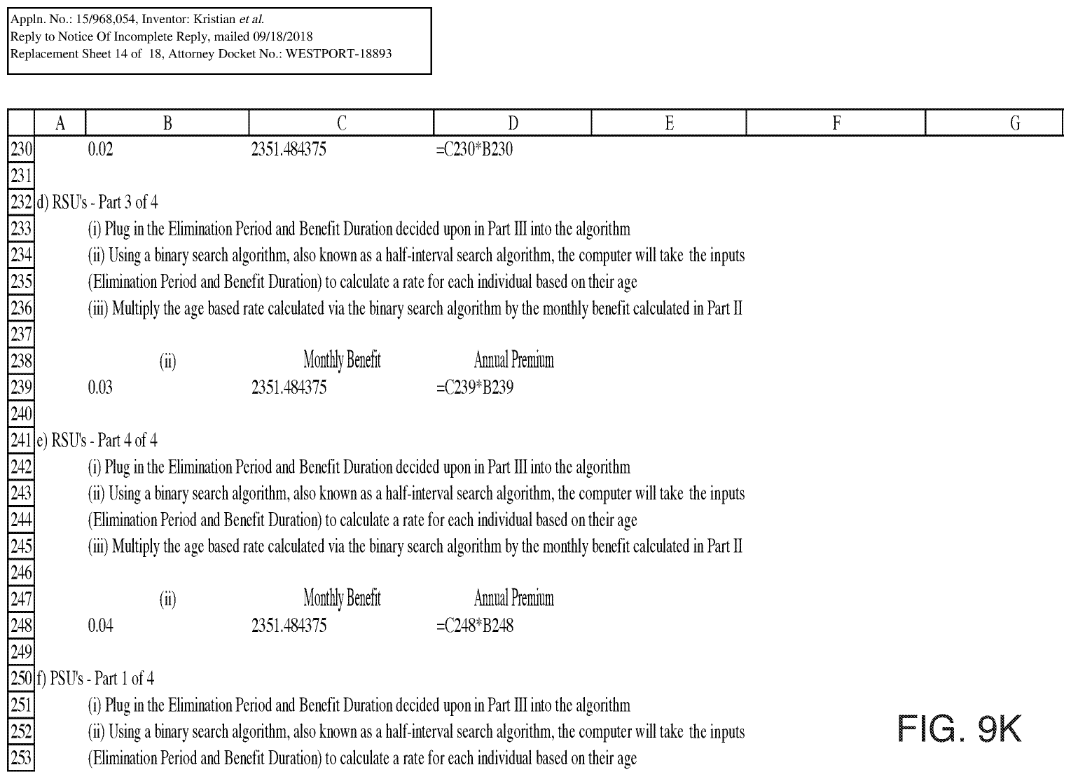

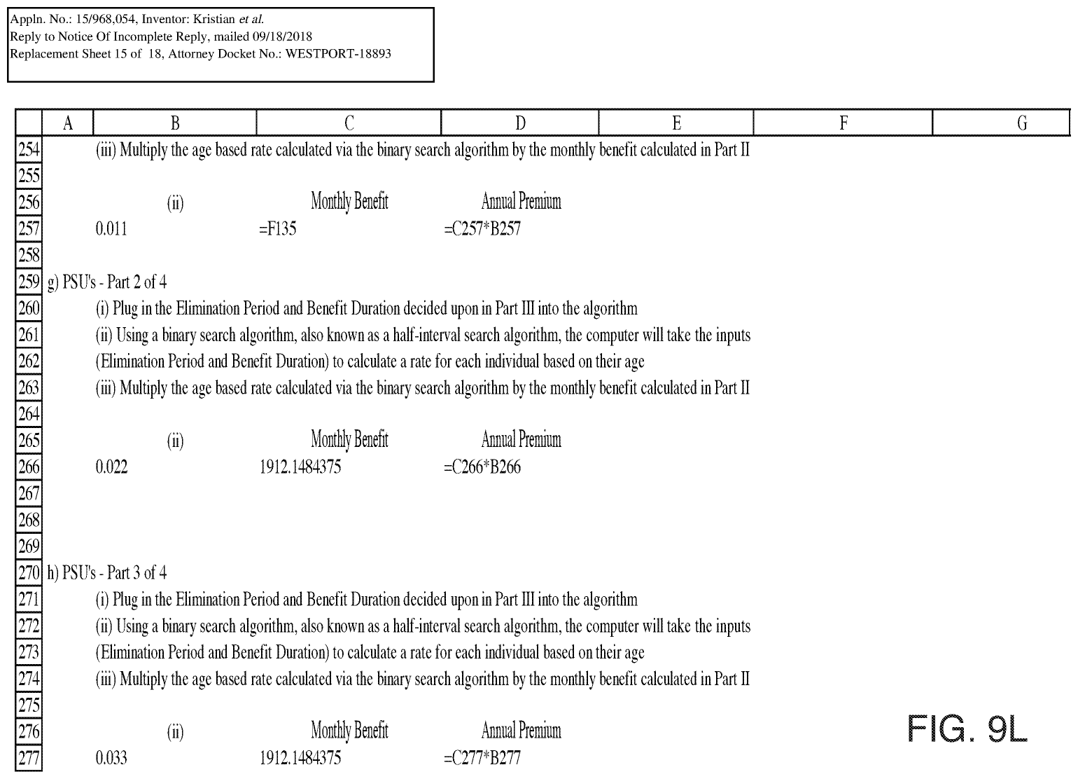

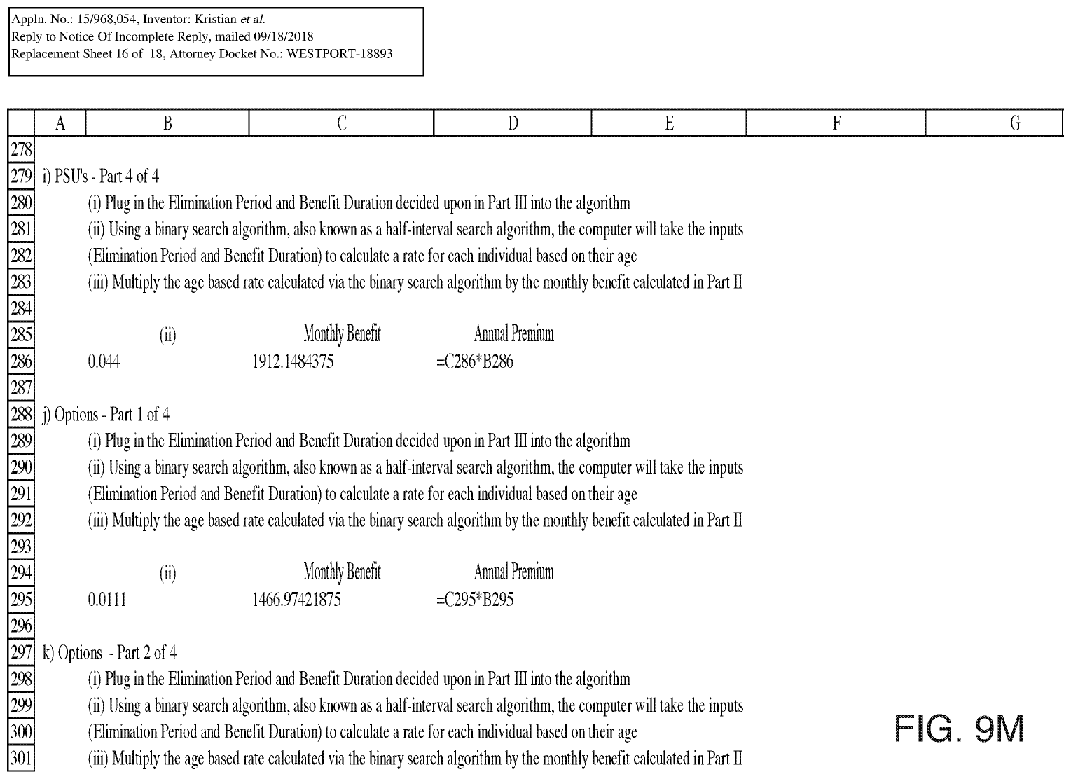

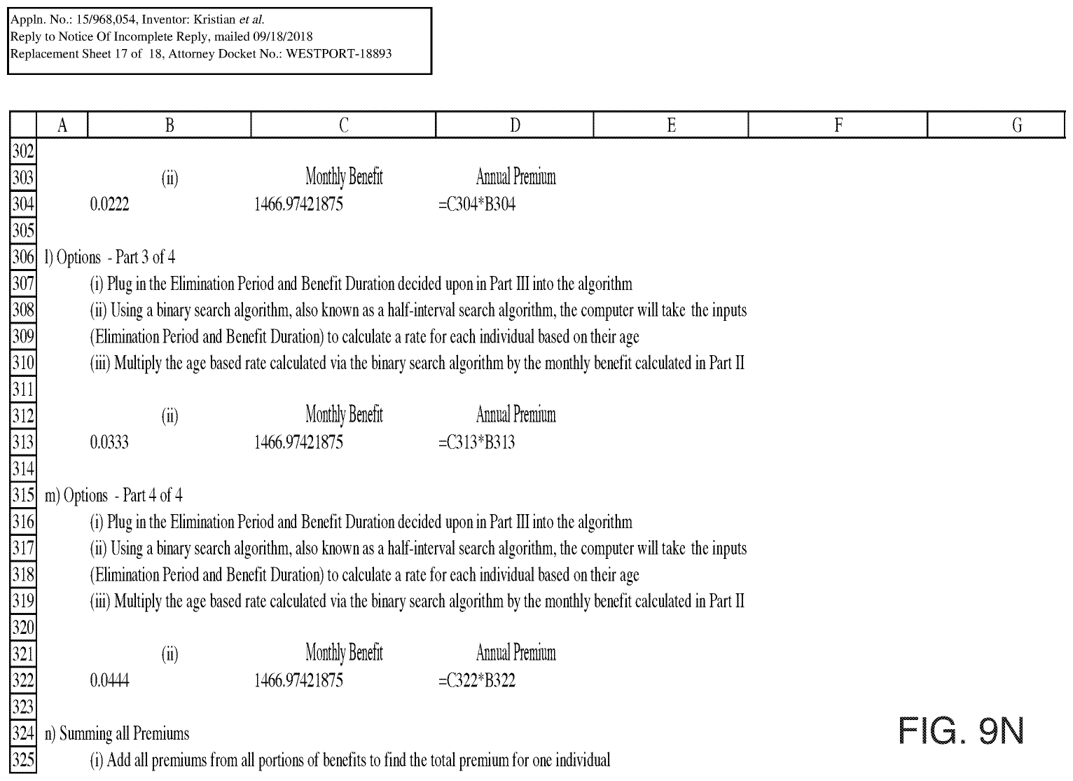

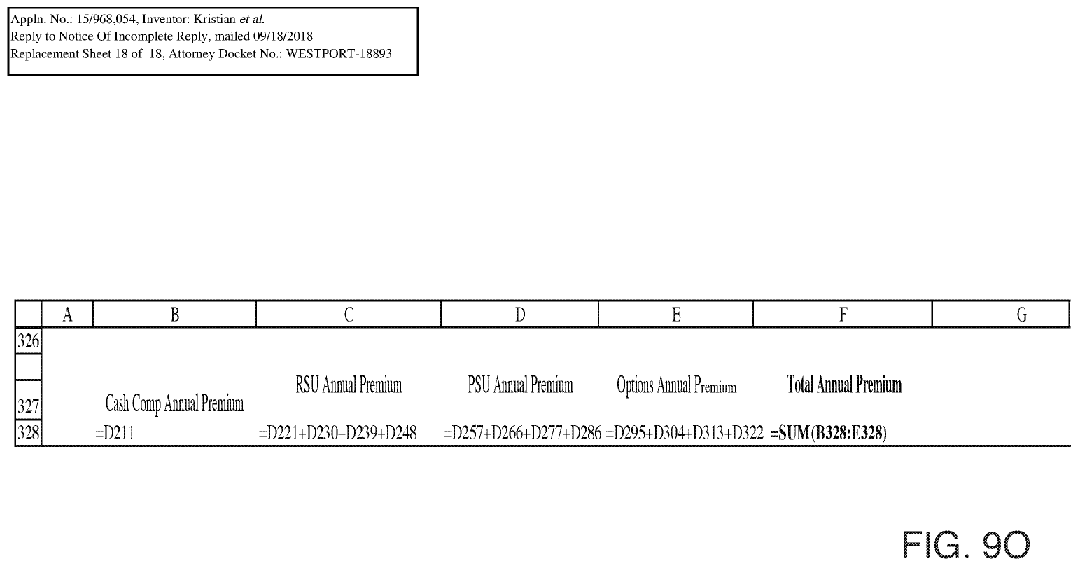

John Smith receives RSUs, which vest over 4 years, from his employer ABC Company. ABC Co. gave underwriters both the grant quantity and FMV for each of the past 4 years. The benefit calculation begins by multiplying the grant quantity by the want FMV in each year. Then the average of each year's total value of RSU grants is taken, based on the lookback period. Then, a percentage of this average is taken to minimize risk of overinsurance and thus moral hazard due to pricing fluctuations in the market; in this example, 75% is used. Finally, a 60% income replacement ratio adjustment is applied to get to an annual maximum stated benefit for the RSU portion of income for the particular individual. See, FIG. 5A.

While the calculations shown in FIG. 5A-B are specific for this example, this process will then be repeated for all eligible executives in Mr. Smith's company, representing groups of eligible insureds that can range up to thousands of individuals.

### Benefit Calculation—Year 2

Mr. Smith's benefits are reset each year at the policy anniversary to keep in line with the most up-to-date income information. Assuming Mr. Smith does not become disabled, he will receive additional RSU grants in 2017 and the stated benefit is recalculated. See, FIG. 5B.

### Premium Calculation

At ABC Company, there is a 6-month elimination period in order to qualify for long-term disability benefits, and the RSU's are vested in 4 years at 25% each year. Therefore, the total annual Stated Benefit for the RSU portion of income ($500,625) is divided into 4 tranches, each of which is 25% of the total amount ($125,156.25 annually, or $10,429.69 monthly). Each tranche is priced up separately as discussed above in part C and the individual premiums for each equity type are summed into one amount to be charged.

### Benefit Payments

In this example, Mr. Smith becomes disabled on Jul. 1, 2018. The “Annualized Vesting Schedule” (FIG. 3) reveals how the stock grants are normally vested, and when Mr. Smith would be able to “cash in” on these grants over time. As mentioned above, these stock grants vest over the course of 4 years. Mr. Smith's total value for the 2014 RSU grant, for example, was $1,200,000. Since this vests over 4 years, each year after 2014 he is able to access 25% of it ($300,000) until the 4 years are up. Under normal circumstances, Mr. Smith would continue to be granted RSU's each year. However, in 2018 and after, Mr. Smith receives no more RSU's since he is disabled. Prior to his disability he was earning roughly $1,000,000 each year from previously granted stock that was becoming vested. In 2019, due to not being granted any RSU's in 2018, his earned income from RSU's decreases, and continues to decrease until it reaches $0 in 2022. See, FIG. 3.

On the other hand, the “Annualized Pay Schedule” (FIG. 4) shows how the EIAP® Equity Benefit calculated above fills in the gap left by the halt of RSU grants due to Mr. Smith's disability. As previously calculated, the 2018 Equity Benefit is $500,625, but the benefit is not fully vested until 2022 and then it will pay out the full 100% for the duration of Mr. Smith's disability or until the maximum benefit duration for his age is reached. See, FIG. 4.

### Taxation

The total amounts of RSU grants paid to Mr. Smith on the “Annualized Vesting Schedule” (FIG. 3) and the “Annualized Pay Schedule” (FIG. 4) are all pre-tax numbers. Conventional methods of determining disability insurance would reduce these amounts to roughly 60% of the total once ordinary income taxes are paid. However, the benefits paid from the above described EIAP® product are tax-free and thus are not further reduced.

We claim:

1. A method to disburse a disability insurance payment for executive equity compensation, comprising:
a) providing:
i) a plurality of executive equity compensation sources; and
ii) a computer comprising an algorithm;
b) calculating a monthly tax-free benefit amount with said algorithm on said computer, wherein said calculating comprises determining an annual intrinsic value of each of said plurality of executive equity compensation sources; and
c) executing a financial transaction that disburses said tax-free benefit amount to an executive repeatedly over a plurality of months.

2. The method of claim 1, wherein said plurality of executive equity compensation sources are selected from the group consisting of stock options, restricted stock units and performance stock units.

3. The method of claim 1, wherein said annual intrinsic value is determined for each year within a lookback period.

4. The method of claim 3, wherein said lookback period does not exceed four (4) years.

5. The method of claim 3, wherein said calculating further comprises summing each of said annual intrinsic values for each respective year into a plurality of total grant annual values.

6. The method of claim 5, wherein said calculating further comprises averaging said plurality of total grant annual values into a rolling average amount.

7. The method of claim 6, wherein said calculating further comprises adjusting said rolling average amount for an average business cycle variation that occurred within said lookback period.

8. The method of claim 7, wherein said calculating further comprises multiplying said adjusted rolling average amount by 60% to create an annual tax-free benefit amount.

9. The method of claim 8, wherein said calculating further comprises dividing said annual tax-free benefit amount by twelve to create said monthly tax-free benefit amount.

10. The method of claim 9, wherein said annual tax-free benefit amount is not a lump sum payment.

11. A method to invoice a disability insurance premium for executive equity compensation, comprising:
a) providing:
i) a plurality of executive equity compensation source vesting schedules; and
ii) a computer comprising an algorithm;
b) calculating an annual premium with said algorithm on said computer using a monthly benefit amount and one of said plurality of equity compensation source vesting schedules;
c) executing a financial transaction that invoices a client.

12. The method of claim 11, wherein said vesting schedule is selected from the group consisting of a 3-year vesting schedule, a 4- year vesting schedule, a cliff vesting schedule and any combination thereof.

13. The method of claim 11, wherein said calculating further comprises said monthly benefit amount is allocated into a plurality of monthly benefit amount tranches based upon an elimination period and a benefit duration of each of said plurality of vesting schedules.

14. The method of claim 13, wherein said calculating further comprises adjusting each of said plurality of monthly benefit tranches with a loading factor-specific actuarial rating matrix.

15. The method of claim 14, wherein said rating matrix comprises information selected from the group consisting of an executive's age, said elimination period and said benefit duration.

16. The method of claim 15, wherein said calculating further comprises applying a census to said rating matrix to calculate a respective premium for each of said plurality of tranches.

17. The method of claim 16, wherein said calculating further comprises summing said respective premium into said annual premium.

18. The method of claim 11, wherein said each of said plurality of executive equity compensation source vesting schedules comprises a plurality of tranches.

19. The method of claim 18, wherein each of said plurality of tranches has a different elimination period and a different benefit duration.

20. A computer readable medium comprising an algorithm comprises a plurality of steps to calculate a disability insurance benefit premium for equity compensation.
